(19) United States
(12) Patent Application Publication
(10) Pub. No.: US 2026/0039702 A1
(43) Pub. Date: Feb. 5, 2026

(54) Communications Network Devices, Lawful Interception System and Method of Lawful Interception

(71) Applicant: TELEFONAKTIEBOLAGET LM ERICSSON (PUBL), Stockholm (SE)

(72) Inventors: Biagio Maione, Napoli (IT); Domenico Raffaele Cione, Caserta (IT); Dario De Vito, Mercato San Severino (SA) (IT); Maurizio Cimino, Napoli (IT); Antonio Panza, Nocera Inferiore (SA) (IT)

(21) Appl. No.: 18/995,351

(22) PCT Filed: Jul. 20, 2022
(86) PCT No.: PCT/EP2022/070370

§ 371 Date: Jan. 16, 2025

(51) Int. Cl. H04L 9/40

(52) U.S. Cl. CPC H04L 63/30

(57) ABSTRACT

A communications network device (100) hosting a lawful interception. LI, administration function. ADMF, the communications network device comprising interface circuitry (102), a processor (104) and a memory (106), said memory containing instructions (110) executable by said processor whereby the communications network device (100) is operative to:—send an X1 request message to a network element, NE, the X1 request message configured to request the NE to send status information of a field of an X1 GetAllDetailsResponse message to the LI ADMF; and—receive an X1 response message from the NE including the requested status information.

### TECHNICAL FIELD

The invention relates to a communications network device hosting a lawful interception, LI, administration function, ADMF. The invention further relates to a communications network device hosting a network element, NE. The invention further relates to a LI system and a method of LI in a communications network.

### BACKGROUND

X1 interfaces are Lawful Interception, LI, interfaces internal to the Communication Service Provider, CSP, for management tasking. X1 interfaces are defined in ETSI TS 103 221-1, for example v1.11.1, “Lawful Interception (LI); Part 1: Internal Network Interface X1 for Lawful Interception”. The X1 interface is based on communication between two entities; the CSP Administration Function (ADMF), and the Network Element, NE, performing interception. The X1 reference model is shown in FIG. 1. A task is a continuous instance of interception at a single NE carried out against a set of LI target identifiers, identified by an X1 Identifier, starting from an activate command and ending with a deactivate command or terminating fault.

LI standard solutions for fifth generation, 5G, communications network onwards are requested to use the new ETSI standard (internal X and external H) Interfaces. ETSI TS 103 221-1 specifies the following requests from the ADMF to a network element, NE, and responses from a NE at clause 6.4:
GetTaskDetails: to request details of a single Task
GetDestinationDetails: to request details of a single Destination
GetNEStatus: to request status of the NE itself
GetAllDetails: requests details of all Tasks, Destinations and the status of the NE itself
ListAllDetails: requests the XIDs of all Tasks and DIDs of all Destinations
GetAllDetails enables the ADMF to obtain, for each active task, detailed information about the task status and events information occurred during the task lifecycle.

More and more ADMF systems are supporting Lawful Interception in 5G using the ETSI TS 103 221-1 X1 standard interface. Historically, among LI ADMF functionalities, Audit&Synch is one of the most important since it allows the ADMF to check for consistency between the LI target list present in the NE and in the ADMF itself on regular basis, and to act upon any mismatches. ETSI TS 103 221-1 provides ADMF with the GetAllDetails request on X1 to implement Auditing.

Since the current Audit procedure can take a very long time it does not allow frequent checks to be made to enforce the integrity of the target list throughout the whole network. In the case of complex and large networks a full Audit can take hours, therefore it cannot be used to determine possible discrepancies within the minimum time required by National Regulations and customers. In addition, the current Audit procedure requires a lot of computing resources, which impacts the performance of the entire LI system.

### SUMMARY

It is an object to enable improved speed and performance of Audit&Synch functionality of a lawful interception, LI, administration function, ADMF.

A first aspect provides a communications network device hosting a lawful interception, LI, administration function, ADMF. The communications network device comprises interface circuitry, a processor and a memory. The memory contains instructions executable by said processor whereby the communications network device is operative to send an X1 request message to a network element, NE, and to receive an X1 response message from the NE. The X1 request message is configured to request the NE to send status information of a field of an X1 GetAllDetailsResponse message to the LI ADMF. The X1 response message from the NE includes the requested status information.

The X1 request functionalities are thereby evolved so that Audit&Synch within an LI system may obtain only necessary information. The ADMF hosted by the communications network is advantageously able to obtain status information about a field that would otherwise have to be provided within a GetAllDetailsResponse along with additional unrequired information. This may enable a more concise, faster retrieval of required information in an Audit&Synch procedure within an LI system, avoiding the use of an X1 GetAllDetailsResponse. This may reduce the overall computational footprint and improve performance of an LI system.

In an embodiment, the X1 request message is configured to request the NE to send status information of a single field of an X1 GetAllDetailsResponse message to the LI ADMF. The ADMF hosted by the communications network is advantageously able to obtain status information about a single field that would otherwise have to be provided within a GetAllDetailsResponse along with additional unrequired information. This may enable a more concise, faster retrieval of required information in an Audit&Synch procedure within an LI system, avoiding the use of an X1 GetAllDetailsResponse. This may reduce the overall computational footprint and improve performance of an LI system.

In an embodiment, the X1 request message is configured to request the NE to send status information of a ListOfTaskResponseDetails field of an X1 GetAllDetailsResponse message to the LI ADMF. The communications network device may enable an LI ADMF to retrieve information about LI Tasks active on an LI system, avoiding the use of an X1 GetAllDetailsResponse which will return additional, unwanted information.

In an embodiment, the X1 request message is configured to request the NE to send TaskDetails of all tasks relating to a LI target list of the NE. The communications network device may enable an LI ADMF to retrieve a LI target list from a NE, without using an X1 GetAllDetailsResponse which will return additional, unwanted information.

In an embodiment, the X1 request message is a GetAllTaskDetails request message. The communications network device is advantageously operating using a new, more specific X1 request message. The GetAllTaskDetails request message enables the ADMF to retrieve all the Task Details currently active on the NE.

In an embodiment, the X1 request message is configured to request the NE to send status information of a ListOfDestinationResponseDetails field of an X1 GetAllDetailsResponse message to the LI ADMF. The communications network device may enable an LI ADMF to retrieve information about LI Destinations active on an LI system, avoiding the use of an X1 GetAllDetailsResponse which will return additional, unwanted information.

In an embodiment, the X1 request message is configured to request the NE to send DestinationDetails of all destinations relating to a LI target list of the NE. The communications network device may enable an LI ADMF to retrieve LI destinations information from a NE, without using an X1 GetAllDetailsResponse which will return additional, unwanted information.

In an embodiment, the X1 request message is a GetAllDestinationDetails request message. The communications network device is advantageously operating using a new, more specific X1 request message. The GetAllDestinationDetails request message enables the ADMF to retrieve all the Destination Details currently active on the NE.

In an embodiment, the X1 request message is an X1 GetAllDetailsRequest message including a request parameter configured to request the NE to send status information of fewer than all of the fields of an X1 GetAllDetailsResponse message to the LI ADMF. The communications network device is advantageously operating using a modified version of the existing GetAllDetailsRequest message, which will cause a NE to return status information of fewer fields than in the standard full GetAllDetailsResponse. This may enable a more concise, faster provision of required information in an Audit&Synch procedure within an LI system, avoiding the use of an X1 GetAllDetailsResponse. This may reduce the overall computational footprint and improve performance of an LI system.

In an embodiment, the request parameter is configured to request the NE to send status information of a single field of an X1 GetAllDetailsResponse message to the LI ADMF.

In an embodiment, the request parameter is configured to request the NE to send status information of a ListOfTaskResponseDetails field of an X1 GetAllDetailsResponse message to the LI ADMF.

In an embodiment, the request parameter is configured to request the NE to send status information of a ListOfDestinationResponseDetails field of an X1 GetAllDetailsResponse message to the LI ADMF.

Corresponding embodiments and advantages also apply to the LI system and method described below.

A second aspect provides a communications network device hosting a network element, NE. The communications network device comprises interface circuitry, a processor and a memory. The memory contains instructions executable by said processor whereby the communications network device is operative to receive an X1 request message from a lawful interception, LI, administration function, ADMF. The X1 request message is configured to request the NE to send status information of a field of an X1 GetAllDetailsResponse message to the LI ADMF. The communications network device is further operative to obtain said status information from a data store of the NE and to send an X1 response message to the LI ADMF including said status information.

The X1 request functionalities are thereby evolved so that Audit&Synch within an LI system may obtain only necessary information. The NE hosted by the communications network is advantageously operable to provide status information about a field that would otherwise have to be provided within a GetAllDetailsResponse along with additional unrequired information. This may enable a more concise, faster provision of required information in an Audit&Synch procedure within an LI system, avoiding the use of an X1 GetAllDetailsResponse. This may reduce the overall computational footprint and improve performance of an LI system.

In an embodiment, the X1 request message is configured to request the NE to send status information of a single field of an X1 GetAllDetailsResponse message to the LI ADMF. The NE hosted by the communications network is advantageously operable to provide status information about a single field that would otherwise have to be provided within a GetAllDetailsResponse along with additional unrequired information. This may enable a more concise, faster provision of required information in an Audit&Synch procedure within an LI system, avoiding the use of an X1 GetAllDetailsResponse. This may reduce the overall computational footprint and improve performance of an LI system.

In an embodiment, the X1 request message is configured to request the NE to send status information of a ListOfTaskResponseDetails field of an X1 GetAllDetailsResponse message to the LI ADMF. The communications network device is advantageously operable to cause the NE to provide information about LI Tasks active on an LI system, avoiding the use of an X1 GetAllDetailsResponse which returns additional, unwanted information.

In an embodiment, the X1 request message is configured to request the NE to send TaskDetails of all tasks relating to a LI target list of the NE. The communications network device is advantageously operable to cause the NE to respond to a specific request to provide a LI target list to the LI ADMF, without using an X1 GetAllDetailsResponse which returns additional, unwanted information.

In an embodiment, the X1 request message is a GetAllTaskDetails request message and the X1 response message is a GetAllTaskDetails response message. The communications network device is advantageously operable to cause the NE to respond to a new, more specific X1 request message. The GetAllTaskDetails request message advantageously causes the NE only to provide all the Task Details currently active on the NE.

In an embodiment, the X1 request message is configured to request the NE to send status information of a ListOfDestinationResponseDetails field of an X1 GetAllDetailsResponse message to the LI ADMF. The communications network device is advantageously operable to cause the NE to provide information about LI Destinations active on an LI system, avoiding the use of an X1 GetAllDetailsResponse which returns additional, unwanted information.

In an embodiment, the X1 request message is configured to request the NE to send Destination Details of all destinations relating to a LI target list of the NE. The communications network device is advantageously operable to cause the NE to provide LI destinations information from the NE, without using an X1 GetAllDetailsResponse which returns additional, unwanted information.

In an embodiment, the X1 request message is a GetAllDestinationDetails request message and the X1 response message is a GetAllDestinationDetails response message. The communications network device is advantageously operable to cause the NE to respond to a new, more specific X1 request message. The GetAllDestinationDetails request message enables an ADMF to retrieve all the Destination Details currently active on the NE.

In an embodiment, the X1 request message is an X1 GetAllDetailsRequest message including a request parameter configured to request the NE to send status information of fewer than all of the fields of an X1 GetAllDetailsResponse message to the LI ADMF. The communications network device is advantageously operable to cause the NE to respond to a modified version of the existing GetAllDetailsRequest message, which will cause the NE to return status information of fewer fields than in the standard full GetAllDetailsResponse. This may enable a more concise, faster provision of required information in an Audit&Synch procedure within an LI system, avoiding the use of an X1 GetAllDetailsResponse. This may reduce the overall computational footprint and improve performance of an LI system.

In an embodiment, the request parameter is configured to request the NE to send status information of a single field of an X1 GetAllDetailsResponse message to the LI ADMF. This may enable a more concise, faster provision of required information in an Audit&Synch procedure within an LI system, avoiding the use of an X1 GetAllDetailsResponse. This may reduce the overall computational footprint and improve performance of an LI system.

In an embodiment, the request parameter is configured to request the NE to send status information of a ListOfTaskResponseDetails field of an X1 GetAllDetailsResponse message to the LI ADMF. The X1 response message is a GetAllTaskDetails response message. The communications network device is advantageously operable to cause the NE to respond to a modified version of the existing GetAllDetailsRequest message, which will cause the NE to return the LI task list of the NE rather than the standard full GetAllDetailsResponse.

In an embodiment, the request parameter is configured to request the NE to send status information of a ListOfDestinationResponseDetails field of an X1 GetAllDetailsResponse message to the LI ADMF. The X1 response message is a GetAllDestinationDetails response message. The communications network device is advantageously operable to cause the NE to respond to a modified version of the existing GetAllDetailsRequest message, which will cause the NE to return the Destinations list of the NE rather than the standard full GetAllDetailsResponse.

Corresponding embodiments and advantages also apply to the LI system and method described below.

A third aspect provides a lawful interception, LI, system 300 comprising a first communications network device hosting a lawful interception, LI, administration function, ADMF, and at least one second communications network device 200 hosting a network element, NE. The first communications network device comprises first interface circuitry, a first processor and a first memory. The first memory contains instructions executable by the first processor whereby the first communications network device is operative to send an X1 request message to the NE, and to receive an X1 response message from the NE. The X1 request message is configured to request the NE to send status information of a field of an X1 GetAllDetailsResponse message to the LI ADMF. The X1 response message from the NE includes the requested status information. The second communications network device comprises second interface circuitry, a second processor and a second memory. The second memory contains instructions executable by the second processor whereby the second communications network device is operative to receive the X1 request message from the LI ADMF. The X1 request message is configured to request the NE to send status information of a field of an X1 GetAllDetailsResponse message to the LI ADMF. The communications network device is further operative to obtain said status information from a data store of the NE and to send an X1 response message to the LI ADMF including said status information.

A fourth aspect provides a method of lawful interception, LI, in a communications network. The method includes an operation of, at an LI administration function, ADMF, sending an X1 request message to a network element, NE. The X1 request message is configured to request the NE to send status information of a field of an X1 GetAllDetailsResponse message to the LI ADMF. The method further includes operations of, at a network element, NE, receiving the X1 request message from the LI ADMF, obtaining said status information from a data store of the NE, and sending an X1 response message to the LI ADMF including said status information. The method further includes an operation of, at the LI ADMF, receiving the X1 response message from the NE including the requested status information.

A fifth aspect provides a computer program comprising instructions which, when executed on at least one processor, cause the at least one processor to carry out steps of the above method of lawful interception in a communications network.

Embodiments of the invention will now be described, by way of example only, with reference to the accompanying drawings.

### BRIEF DESCRIPTION OF THE DRAWINGS

FIG. 1 is a block diagram illustrating a prior art lawful interception, LI, system;

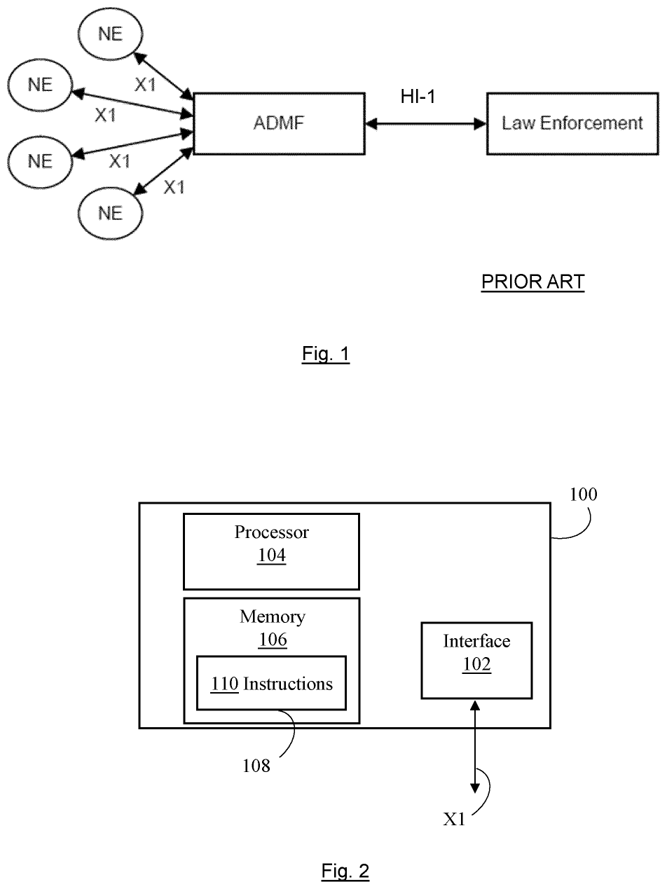

FIG. 2 is a block diagram illustrating an embodiment of a communications network device hosting an LI administration function, ADMF;

FIG. 3 is a block diagram illustrating an embodiment of a communications network device hosting a network element, NE;

FIG. 4 is a block diagram illustrating an embodiment of an LI system;

FIG. 5 is a flowchart illustrating an embodiment of method steps; and

FIGS. 6 to 9 are signalling diagrams illustrating exchanges of signals in embodiments of method steps.

### DETAILED DESCRIPTION

The same reference numbers will be used for corresponding features in different embodiments.

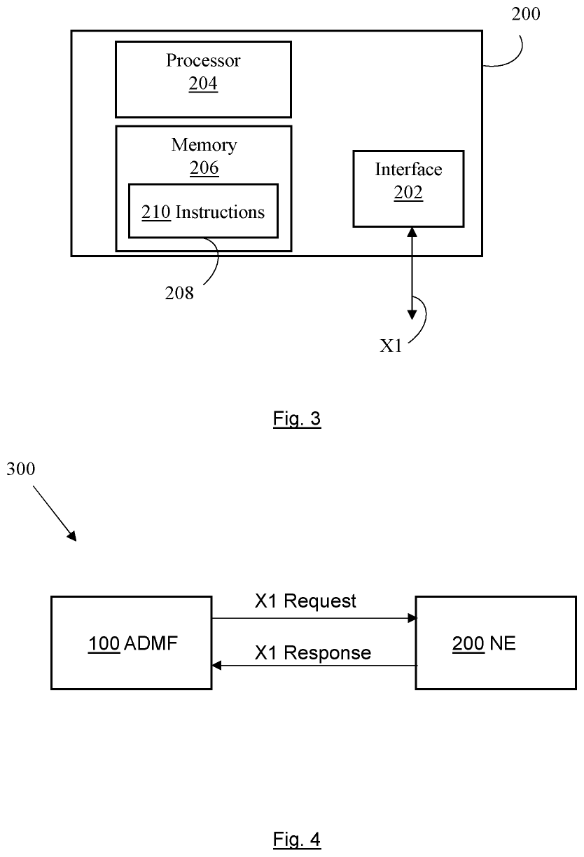

Referring to FIG. 2, an embodiment provides a communications network device 100 hosting a lawful interception, LI, administration function, ADMF. The communications network device 100 comprises interface circuitry 102, a processor 104 and a memory 106. The memory 106 contains instructions 110 executable by the processor 104 whereby the communications network device 100 is operative to send an X1 request message to a network element, NE, and receive an X1 response message from the NE. The X1 request message is configured to request the NE to send status information of a field of an X1 GetAllDetailsResponse message to the LI ADMF. The X1 response message from the NE includes the requested status information.

The standard X1 GetAllDetailsResponse message is defined at clause 6.4.5.1, Table 31, of ETSI TS 103 221-1, for example v1.11.1, as including the following fields: NEStatusDetails; ListOfTaskResponseDetails; and ListOfDestinationResponseDetails.

In an embodiment, the X1 request message is configured to request the NE to send status information of a single field of an X1 GetAllDetailsResponse message to the LI ADMF.

In an embodiment, the X1 request message is configured to request the NE to send status information of a ListOfTaskResponseDetails field of an X1 GetAllDetailsResponse message to the LI ADMF.

In an embodiment, the X1 request message is configured to request the NE to send TaskDetails of all tasks relating to a LI target list of the NE.

In an embodiment, the X1 request message is a GetAllTaskDetails request message. The ADMF can use a GetAllTaskDetails request to retrieve from the NE all the details of LI tasks that are currently active at the NE, i.e. tasks that have previously been activated by NE, as defined at clause 6.2.1.2 (“TaskDetails”) of ETSI TS 103 221-1, for example v1.11.1.

The GetAllTaskDetails request message has the standard X1 Message Details structure as defined at clause 6.1, Table 1 of ETSI TS 103 221-1, for example v1.11.1. In addition to the information in Table 1, the GetAllTaskDetails request shall indicate the type of request being made. No additional fields are required.

In an embodiment, the X1 request message is configured to request the NE to send status information of a ListOfDestinationResponseDetails field of an X1 GetAllDetailsResponse message to the LI ADMF.

In an embodiment, the X1 request message is configured to request the NE to send DestinationDetails of all destinations relating to a LI target list of the NE.

In an embodiment, the X1 request message is a GetAllDestinationDetails request message. The ADMF can use a GetAllDestinationDetails request to retrieve from the NE all the details of destinations that are currently active at the NE, i.e. destinations that have previously been activated by NE, as defined at clause 6.3.1.2 (“DestinationDetails”) of ETSI TS 103 221-1, for example v1.11.1.

The GetAllDestinationDetails request message has the standard X1 Message Details structure as defined at clause 6.1, Table 1 of ETSI TS 103 221-1, for example v1.11.1. In addition to the information in Table 1, the GetAllDestinationDetails request shall indicate the type of request being made. No additional fields are required.

In an embodiment, the X1 request message is an X1 GetAllDetailsRequest message including a request parameter configured to request the NE to send status information of fewer than all of the fields of an X1 GetAllDetailsResponse message to the LI ADMF.

The standard X1 GetAllDetailsResponse message is defined at clause 6.4.5.1, Table 31, of ETSI TS 103 221-1, for example v1.11.1, as including the following fields: NEStatusDetails; ListOfTaskResponseDetails; and ListOfDestinationResponseDetails. The request parameter may be configured to request the NE to send status information of one or two of these fields.

In an embodiment, the request parameter is configured to request the NE to send status information of a single field of an X1 GetAllDetailsResponse message to the LI ADMF.

In an embodiment, the request parameter is configured to request the NE to send status information of a ListOfTaskResponseDetails field of an X1 GetAllDetailsResponse message to the LI ADMF.

In an embodiment, the request parameter is configured to request the NE to send TaskDetails of all tasks relating to a LI target list of the NE.

In an embodiment, the request parameter is configured to request the NE to send status information of a ListOfDestinationResponseDetails field of an X1 GetAllDetailsResponse message to the LI ADMF.

In an embodiment, the request parameter is configured to request the NE to send DestinationDetails of all destinations relating to a LI target list of the NE.

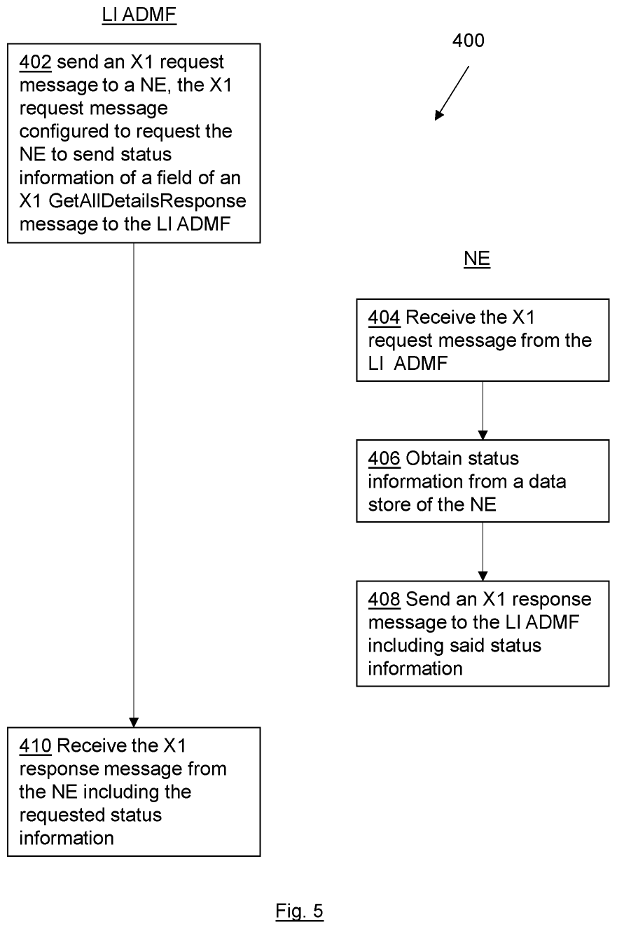

Referring to FIG. 3, an embodiment provides a communications network device 200 hosting a network element, NE. The communications network device comprises interface circuitry 202, a processor 204 and a memory 206. The memory 206 contains instructions 210 executable by the processor 204 whereby the communications network device 200 is operative to receive an X1 request message from an LI ADMF. The X1 request message is configured to request the NE to send status information of a field of an X1 GetAllDetailsResponse message to the LI ADMF. The communications network device 200 is further operative to obtain the status information from a data store of the NE and to send an X1 response message to the LI ADMF including the requested status information.

In an embodiment, the X1 request message is configured to request the NE to send status information of a single field of an X1 GetAllDetailsResponse message to the LI ADMF.

In an embodiment, the X1 request message is configured to request the NE to send status information of a ListOfTaskResponseDetails field of an X1 GetAllDetailsResponse message to the LI ADMF.

In an embodiment, the X1 request message is configured to request the NE to send TaskDetails of all tasks relating to a LI target list of the NE.

In an embodiment, the X1 request message is a GetAllTaskDetails request message, as described above, and the X1 response message is a GetAllTaskDetails response message.

The GetAllTaskDetails response message has the standard X1 Message Details structure as defined at clause 6.1, Table 1 of ETSI TS 103 221-1, for example v1.11.1. In addition to the information in Table 1, the GetAllTaskDetails response shall include a ListOfTaskDetails field, as defined in the following Table “GetAllTaskDetailsResponse”:

TABLE
GetAllTaskDetailsResponse

| Field | Description | Format | M/C/O |
|---|---|---|---|
| ListOfTaskDetails | The response shall include a list | See | M |
| | of TaskDetails structures (as | clauses | |
| | specified in the clause 6.2.1.2, | 6.2.1.2 | |
| | without the | | |
| | TaskDetailsExtensions) for all | | |
| | tasks. If there are no tasks, an | | |
| | empty list shall be returned - | | |
| | this is not an error. | | |

As defined at clause 6.2.1.1 and 6.2.1.2 of ETSI TS 103 221-1, TaskDetails are target and interception details. The TaskDetails structure is defined in ETSI TS 103 221-1 at Table 4:

TABLE 4
TaskDetails

| Field | Description | Format | M/C/O |
|---|---|---|---|
| XID | Uniquely identifies the Task. | UUIDv4 (see clause 5.1) | M |
| | There may be more than one | | |
| | different Task relating to the same | | |
| | target identifier (two distinct XIDs). | | |
| | The X1 interface supports delivery of | | |
| | this situation (i.e. it is not considered | | |
| | an error on the X1 interface). | | |
| TargetIdentifiers | List of criteria which are used to | Each TargetIdentifier given | M |
| | identify the traffic to be intercepted. | follows one of the formats | |
| | Where multiple criteria are present, | given in table 5. | |
| | all criteria are required to be | | |
| | matched. If an NE cannot target | | |
| | based on the criteria specified (e.g. | | |
| | due to an unsupported format or | | |
| | inappropriate combination of | | |
| | identifiers) the NE shall reject the | | |
| | request with an appropriate error. | | |
| | It is an implementation decision | | |
| | which identifiers and combinations of | | |
| | identifiers are supported. | | |
| DeliveryType | Statement of whether to deliver X2 | Enumerated value - one of | M |
| | and/or X3 | “X2Only”, “X3Only” and | |
| | | “X2andX3” | |
| ListOfDIDs | Details of where to send the | List of Destination Identifiers | M |
| | intercepted traffic. | (DID) referencing the | |
| | It is an implementation decision for | desired delivery destination | |
| | the NE to determine how to duplicate | records. | |
| | traffic if multiple destinations are | | |
| | specified, or if multiple destinations | | |
| | are supported. | | |
| TaskDetailsExtensions | One or more extension placeholders; | See annex B. | O |
| | each may be populated by a list of | | |
| | elements defined by external | | |
| | specifications. | | |

X2 is the interface that is used to transmit intercepted signalling and X3 is the interface that is used for transmission of intercepted content. Both X2 and X3 are specified in ETSI TS 103 221-2, for example v1.5.1

In an embodiment, the X1 request message is configured to request the NE to send status information of a ListOfDestinationResponseDetails field of an X1 GetAllDetailsResponse message to the LI ADMF.

In an embodiment, the X1 request message is configured to request the NE to send DestinationDetails of all destinations relating to a LI target list of the NE.

In an embodiment, the X1 request message is a GetAllDestinationDetails request message and the X1 response message is a GetAllDestinationDetails response message.

The GetAllDestinationDetails response message has the standard X1 Message Details structure as defined at clause 6.1, Table 1 of ETSI TS 103 221-1, for example v1.11.1. In addition to the information in Table 1, the GetAllDestinationDetails response shall include a ListOfDestinationDetails field, as defined in the following Table “GetAllDestinationDetailsResponse”:

TABLE
GetAllDestinationDetailsResponse

| Field | Description | Format | M/C/O |
|---|---|---|---|
| ListOfDestina- | The response shall include a list | See | M |
| tionDetails | of DestinationDetails structures | clauses | |
| | (as specified in the clause | 6.3.1.2 | |
| | 6.3.1.2) for all destinations. If | | |
| | there are no destinations, an | | |
| | empty list shall be returned - this | | |
| | is not an error. | | |

As defined at clause 6.3.1.2 of ETSI TS 103 221-1, DestinationDetails relate to the delivery of information from the NE to a Destination. Any further onward forwarding of data is handled by other administrative, mediation or delivery functions (out of scope of ETSI TS 103 221-1). The DestinationDetails structure is defined in ETSI TS 103 221-1 at Table 14:

TABLE 14
DestinationDetails

| Field | Description | Format | M/C/O |
|---|---|---|---|
| DID | Destination Identifier which uniquely | UUIDv4 (see clause 5.1) | M |
| | identifies the destination | | |
| FriendlyName | A human-readable name associated with | Free-text string | O |
| | the delivery destination | | |
| DeliveryType | Statement of whether to deliver X2 | Enumerated value - one of | M |
| | and/or X3 to this destination | “X2Only”, “X3Only” and | |
| | | “X2andX3” | |
| DeliveryAddress | One of the values from table 15 | As defined in table 15 | M |

In an embodiment, the X1 request message is an X1 GetAllDetailsRequest message including a request parameter configured to request the NE to send the status information of fewer than all of the fields of an X1 GetAllDetailsResponse message to the LI ADMF.

ETSI TS 103 221-1 defines the standard GetAllDetailsRequest at clause 6.4.5.1, Table 30, as including no request parameters. The X1 GetAllDetailsRequest message of this embodiment is a new version of this standard GetAllDetailsRequest, as defined in the following Table 30A:

TABLE 30A
GetAllDetailsRequest

| Field | Description | Format | M/C/O |
|---|---|---|---|
| InfoRe- | Indicates the Information requested. | See | O |
| questDetails | If omitted the details of all Tasks, | Table | |
| | Destinations and the status of the | 30B | |
| | NE itself are requested. | | |

TABLE 30B
InfoRequestDetails

| Field | Description | Format | M/C/O |
|---|---|---|---|
| InfoTasksRequestDetails | It indicates if the response shall | It shall be | O |
| | include the | encoded as | |
| | ListOfTaskResponseDetails field. | follows: “Yes” = | |
| | If Requested, Table 30C shall | Requested, “No” = | |
| | indicates if the TaskStatus is | Not Requested. | |
| | requested or not. | | |
| InfoDestinationRequestDetails | It indicates if the response shall | It shall be | O |
| | include the | encoded as | |
| | ListOfDestinationResponseDetails | follows: “Yes” = | |
| | field | Requested, “No” = | |
| | | Not Requested. | |
| InfoNEstatusRequestDetails | It indicates if the response shall | It shall be | O |
| | include the NEStatusDetails | encoded as | |
| | field | follows: “Yes” = | |
| | | Requested, “No” = | |
| | | Not Requested. | |

TABLE 30C
TaskStatus

| Field | Description | Format | M/C/O |
|---|---|---|---|
| InfoTasksStatusRequest | It indicates if response shall | It shall be encoded | C |
| | include the TaskStatus in the | as follows: “Yes” = | |
| | ListOfTaskResponseDetails | Requested, “No” = | |
| | field | Not Requested. | |

The new GetAllDetailsRequest message request parameters may be configured to include one or two of the InfoRequestDetails and, if the request parameters include InfoTasksRequestDetails the request parameters may be further configured to indicate whether the response shall include the TaskStatus.

In an embodiment, the request parameter is configured to request the NE to send status information of a single field of an X1 GetAllDetailsResponse message to the LI ADMF. This may be achieved by configuring the request parameters to include a single one of the fields of Table 30B.

In an embodiment, the request parameter is configured to request the NE to send status information of a ListOfTaskResponseDetails field of an X1 GetAllDetailsResponse message to the LI ADMF. As indicated at Table 30B, this is may be achieved by including the request parameter Info TasksRequestDetails. The X1 response message may be a GetAllTaskDetails response message, as described above.

In an embodiment, the request parameter is configured to request the NE to send status information of a ListOfDestinationResponseDetails field of an X1 GetAllDetailsResponse message to the LI ADMF. As indicated at Table 30B, this may be achieved by including the request parameter InfoDestinationRequestDetails. The X1 response message may be a GetAllDestinationDetails response message, as described above.

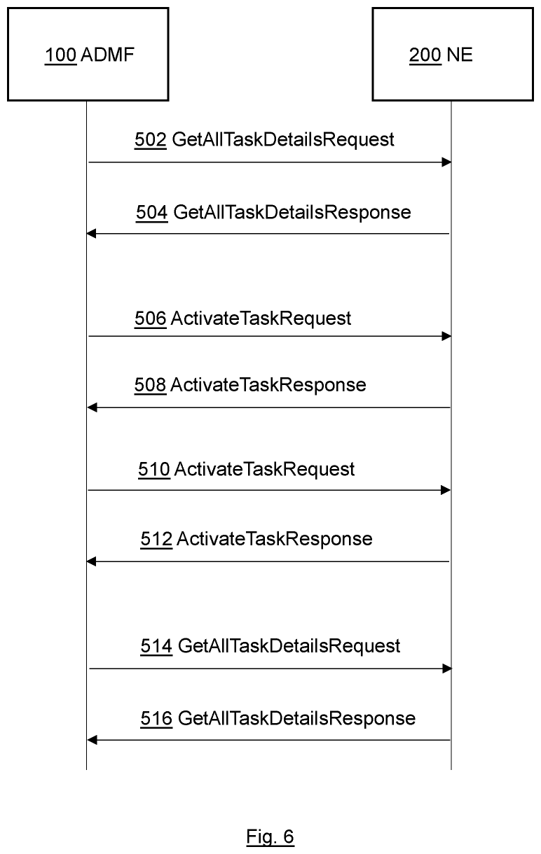

Referring to FIG. 4, an embodiment provides a LI system 300 comprising a first communications network device 100 hosting a LI ADMF, as described above, and at least one second communications network device 200 hosting a network element, NE, as described above.

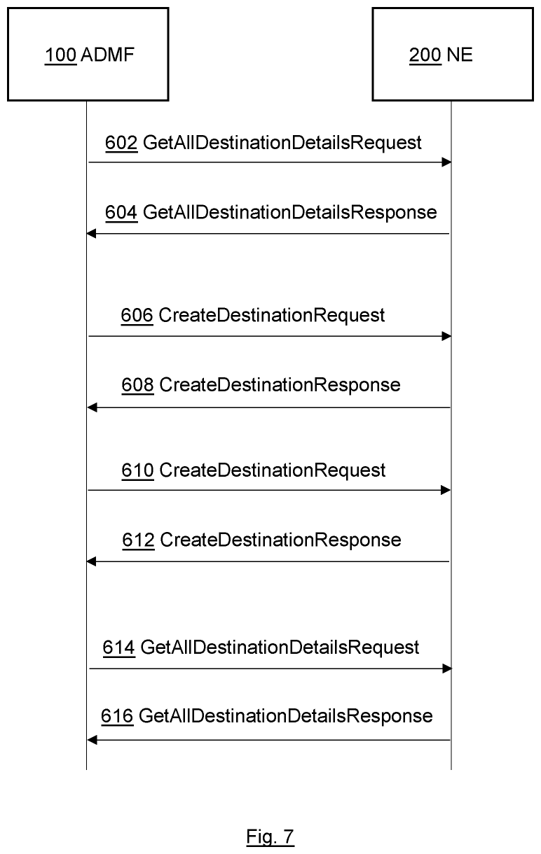

An embodiment provides a method 400, illustrated in FIG. 5, of LI in a communications network. The method includes the following operations. At an LI ADMF, sending 402 an X1 request message to a network element, NE. The X1 request message is configured to request the NE to send status information of a field of an X1 GetAllDetailsResponse message to the LI ADMF. At the NE, receiving 404 the X1 request message from the LI ADMF, obtaining 406 the requested status information from a data store of the NE, and sending 408 an X1 response message to the LI ADMF including the requested status information. At the LI ADMF, receiving 410 the X1 response message from the NE including the requested status information.

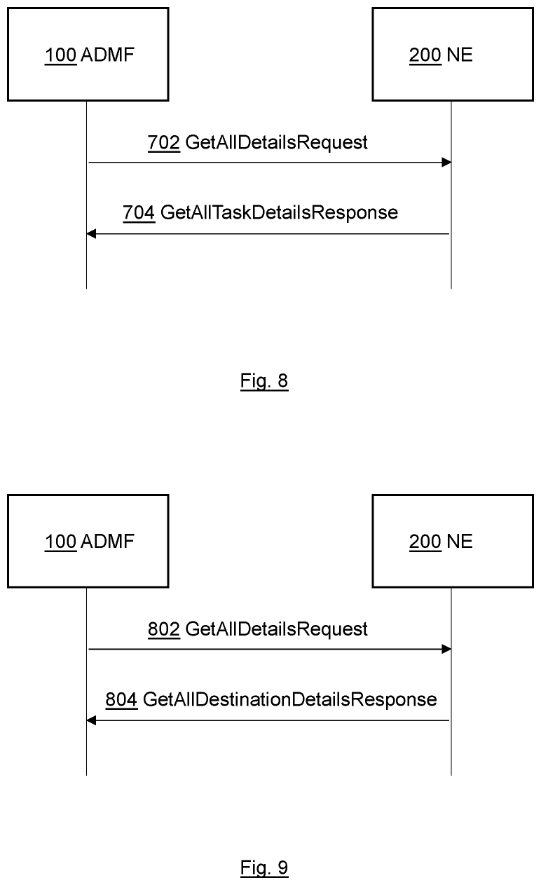

FIG. 6 illustrates signalling within the LI system of FIG. 4, including steps of a method of LI in a communications network according to an embodiment.

ADMF 100 sends a GetAllTaskDetailsRequest message 502, as described above, to the NE 200, on the X1 interface. There are currently no activated LI tasks at the NE, which sends a GetAllTaskDetailsResponse message 504 back to the ADMF containing an empty ListOfTaskDetails field:

ListOfTaskDetails: [ ]

Suppose now that ADMF 100 creates a destination with DID 4zb6d9f8-ej88-4890-953f-1c48fef91d9c. Then, it activates a couple of tasks using the X1 interface. The ADMF sends a first Activate TaskRequest message 506 to the NE including the following task information:

XID: 3ab6d9f8-ed88-4090-953f-1c48fef91d9c
TargetIdentifiers: [460230123001, 460230123002]
DeliveryType: X2
ListOfDIDs: [4zb6d9f8-ej88-4890-953f-1c48fef91d9c]

NE 200 sends a first ActivateTaskResponse message 508 back to the ADMF confirming activation of the task. The ADMF then sends a second ActivateTaskRequest message 510 to the NE containing the following task information:

XID: 9hkgd4a1-ed88-4090-953f-1c48fef91d9c
TargetIdentifiers: [460230123006]
DeliveryType: X2
ListOfDIDs: [4zb6d9f8-ej88-4890-953f-1c48fef91d9c]

NE 200 sends a second ActivateTaskResponse message 512 back to the ADMF confirming activation of the task. When the ADMF sends a second GetAllTaskDetailsRequest message 514 to the NE 200, the NE responds with a GetAllTaskDetailsResponse message 516 back to the ADMF containing the following information about the currently active tasks:

```
  ListOfTaskDetails: [
    TaskDetails: {
        XID: 3ab6d9f8-ed88-4090-953f-1c48fef91d9c
      TargetIdentifiers: [460230123001, 460230123002]
      DeliveryType: X2
      ListOfDIDs: [4zb6d9f8-ej88-4890-953f-1c48fef91d9c]
    },
TaskDetails: {
      XID: 9hkgd4a1-ed88-4090-953f-1c48fef91d9c
      TargetIdentifiers: [460230123006]
      DeliveryType: X2
      ListOfDIDs: [4zb6d9f8-ej88-4890-953f-1c48fef91d9c]
    }
  ]
```

FIG. 7 illustrates signalling within the LI system of FIG. 4, including steps of a method of LI in a communications network according to an embodiment.

ADMF 100 sends a GetAllDestinationDetailsRequest message 602, as described above, to the NE 200, on the X1 interface. There are currently no created LI destinations at the NE, which sends a GetAllDestinationDetailsResponse message 604 back to the ADMF containing an empty ListOfDestinationDetails field:

ListOfDestinationDetails: [ ]

ADMF 100 then creates two destinations at the NE using the X1 interface. The ADMF sends a first CreateDestinationRequest message 606 to the NE including the following destination information:

DID: 3ab6d9f8-ed88-4090-953f-1c48fef91d9c
FriendlyName: ‘First destination’
DeliveryType: X2
DeliveryAddress: 10.0.30.10:3000

NE 200 sends a first ActivateDestinationResponse message 608 back to the ADMF confirming creation of the destination. The ADMF then sends a second CreateDestinationRequest message 610 to the NE containing the following destination information:

DID: 1tf8h2k3-ed88-4090-953f-1c48fef91d9c
FriendlyName: ‘Second destination’
DeliveryType: X2
DeliveryAddress: 10.0.30.60:3000

NE 200 sends a second ActivateDestinationResponse message 612 back to the ADMF confirming creation of the destination. When the ADMF sends a second GetAllDestinationDetailsRequest message 614 to the NE 200, the NE responds with a GetAllDestinationDetailsResponse message 616 back to the ADMF containing the following information about the currently created destinations:

```
  ListOfDestinationDetails: [
    DestinationDetails: {
        DID: 3ab6d9f8-ed88-4090-953f-1c48fef91d9c
      FriendlyName: ‘First destination’
      DeliveryType: X2
      DeliveryAddress: 10.0.30.10:3000
    },
DestinationDetails: {
      DID: 1tf8h2k3-ed88-4090-953f-1c48fef91d9c
      FriendlyName: ‘Second destination’
      DeliveryType: X2
      DeliveryAddress: 10.0.30.60:3000
    }
  ]
```

FIG. 8 illustrates signalling within the LI system of FIG. 4, including steps of a method of LI in a communications network according to an embodiment.

ADMF 100 sends a GetAllDetailsRequest message 702, as described above, to the NE 200, on the X1 interface. The GetAllDetailsRequest message includes the request parameter field Info TasksRequestDetails. The NE responds by sending a GetAllTaskDetailsResponse message 704 to the ADMF containing the following information about the currently active tasks, previously activated as described above:

```
  ListOfTaskDetails: [
    TaskDetails: {
        XID: 3ab6d9f8-ed88-4090-953f-1c48fef91d9c
      TargetIdentifiers: [460230123001, 460230123002]
      DeliveryType: X2
      ListOfDIDs: [4zb6d9f8-ej88-4890-953f-1c48fef91d9c]
    },
TaskDetails: {
      XID: 9hkgd4a1-ed88-4090-953f-1c48fef91d9c
      TargetIdentifiers: [460230123006]
      DeliveryType: X2
      ListOfDIDs: [4zb6d9f8-ej88-4890-953f-1c48fef91d9c]
    }
  ]
```

FIG. 9 illustrates signalling within the LI system of FIG. 4, including steps of a method of LI in a communications network according to an embodiment.

ADMF 100 sends a GetAllDetailsRequest message 802, as described above, to the NE 200, on the X1 interface. The GetAllDetailsRequest message includes the request parameter field InfoDestinationRequestDetails. The NE responds with a GetAllDestinationDetailsResponse message 804 back to the ADMF containing the following information about the currently created destinations, previously created as described above:

```
  ListOfDestinationDetails: [
    DestinationDetails: {
        DID: 3ab6d9f8-ed88-4090-953f-1c48fef91d9c
      FriendlyName: ‘First destination’
      DeliveryType: X2
      DeliveryAddress: 10.0.30.10:3000
    },
DestinationDetails: {
      DID: 1tf8h2k3-ed88-4090-953f-1c48fef91d9c
      FriendlyName: ‘Second destination’
      DeliveryType: X2
      DeliveryAddress: 10.0.30.60:3000
    }
  ]
```

An embodiment provides a computer program 108 comprising instructions which, when executed on at least one processor, cause the at least one processor to carry out steps of the method 400.

An embodiment provides a computer program 208 comprising instructions which, when executed on at least one processor, cause the at least one processor to carry out steps of the method 400.

1.-27. (canceled)

28. A communications network device configured to implement a lawful interception (LI) administration function (ADMF), the communications network device comprising interface circuitry, a processor, and a memory comprising instructions executable by the processor, wherein execution of the instructions by the processor causes the communications network device to:
send, to a network element (NE), an X1 request message configured to request the NE to send, to the LI ADMF, status information of a field of an X1 GetAllDetailsResponse message; and
receive from the NE an X1 response message that includes the requested status information.

29. The communications network device of claim 28, wherein the X1 request message is configured to request the NE to send, to the LI ADMF, status information of a single field of an X1 GetAllDetailsResponse message.

30. The communications network device of claim 29, wherein the X1 request message is configured to request the NE to send, to the LI ADMF, status information of a ListOfTaskResponseDetails field of an X1 GetAllDetailsResponse message.

31. The communications network device of claim 30, wherein the X1 request message is configured to request the NE to send, to the LI ADMF, TaskDetails of all tasks relating to a LI target list of the NE.

32. The communications network device of claim 29, wherein the X1 request message is configured to request the NE to send, to the LI ADMF, status information of a ListOfDestinationResponseDetails field of an X1 GetAllDetailsResponse message.

33. The communications network device of claim 32, wherein the X1 request message is configured to request the NE to send, to the LI ADMF, DestinationDetails of all destinations relating to a LI target list of the NE.

34. The communications network device of claim 28, wherein the X1 request message is an X1 GetAllDetailsRequest message that includes a request parameter configured to request the NE to send, to the LI ADMF, status information of fewer than all of the fields of an X1 GetAllDetailsResponse message.

35. A communications network device configured to implement a network element (NE), the communications network device comprising interface circuitry, a processor, and a memory comprising instructions executable by the processor, wherein execution of the instructions by the processor causes the communications network device to:
receive, from a lawful interception (LI) administration function (ADMF), an X1 request message configured to request the NE to send, to the LI ADMF, status information of a field of an X1 GetAllDetailsResponse message;
obtain the requested status information from a data store of the NE; and
send an X1 response message to the LI ADMF including the requested status information obtained from the data store.

36. The communications network device of claim 35, wherein the X1 request message is configured to request the NE to send, to the LI ADMF, status information of a single field of an X1 GetAllDetailsResponse message.

37. The communications network device of claim 36, wherein the X1 request message is configured to request the NE to send, to the LI ADMF, status information of a ListOfTaskResponseDetails field of an X1 GetAllDetailsResponse message.

38. The communications network device of claim 37, wherein the X1 request message is configured to request the NE to send, to the LI ADMF, TaskDetails of all tasks relating to a LI target list of the NE.

39. The communications network device of claim 36, wherein the X1 request message is configured to request the NE to send, to the LI ADMF, status information of a ListOfDestinationResponseDetails field of an X1 GetAllDetailsResponse message.

40. The communications network device of claim 39, wherein the X1 request message is configured to request the NE to send, to the LI ADMF, DestinationDetails of all destinations relating to a LI target list of the NE.

41. The communications network device of claim 35, wherein the X1 request message is an X1 GetAllDetailsRequest message that includes a request parameter configured to request the NE to send, to the LI ADMF, status information of fewer than all of the fields of an X1 GetAllDetailsResponse message.

42. The communications network device of claim 41, wherein the request parameter is configured to request the NE to send, to the LI ADMF, status information of a single field of an X1 GetAllDetailsResponse message.

43. The communications network device of claim 42, wherein:
the request parameter is configured to request the NE to send, to the LI ADMF, status information of a ListOfTaskResponseDetails field of an X1 GetAllDetailsResponse message; and
the X1 response message is a GetAllTaskDetails response message.

44. The communications network device of claim 42, wherein:
the request parameter is configured to request the NE to send, to the LI ADMF, status information of a ListOfDestinationResponseDetails field of an X1 GetAllDetailsResponse message to the LI ADMF; and
the X1 response message is a GetAllDestinationDetails response message.

45. A lawful interception (LI) system comprising:
the communications network device as claimed in claim 28; and
at least one second communications network device configured to implement respective at least one network element (NE),
wherein each second communications network device comprises interface circuitry, a processor, and a memory comprising instructions executable by the processor, wherein execution of the instructions by the processor causes the second communications network device to:
receive, from a lawful interception (LI) administration function (ADMF), an X1 request message configured to request the NE to send, to the LI ADMF, status information of a field of an X1 GetAllDetailsResponse message;
obtain the requested status information from a data store of the NE; and
send an X1 response message to the LI ADMF including the requested status information obtained from the data store.

46. A method of lawful interception (LI) in a communications network, the method comprising:
sending, by an LI administration function (ADMF) to a network element (NE), an X1 request message configured to request the NE to send, to the LI ADMF, status information of a field of an X1 GetAllDetailsResponse message;
receiving, by the NE, the X1 request message from the LI ADMF;
obtaining, by the NE, said the requested status information from a data store of the NE; and
sending, by the NE to the LI ADMF, an X1 response message including the requested status information obtained from the data store; and
receiving, by the LI ADMF from the NE, the X1 response message including the requested status information.
